(19) United States
(12) Patent Application Publication
(10) Pub. No.: US 2019/0096547 A1
(43) Pub. Date: Mar. 28, 2019

(54) DIFFERENTIAL TRANSMISSION CABLE AND WIRE HARNESS

(71) Applicant: Yazaki Corporation, Tokyo (JP)

(72) Inventor: Taketo KUMADA, Susono-shi (JP)

(73) Assignee: Yazaki Corporation, Tokyo (JP)

(21) Appl. No.: 16/107,353

(22) Filed: Aug. 21, 2018

(30) Foreign Application Priority Data
Sep. 25, 2017 (JP) 2017-183263

(51) Int. Cl. H01B 11/12; H01B 3/30; H01B 11/00; H01B 7/02; H01B 7/17; H01B 7/00

(52) U.S. Cl. CPC H01B 11/12; H01B 3/30; H01B 7/0045; H01B 7/0208; H01B 7/17; H01B 11/002

(57) ABSTRACT

A differential transmission cable and a wire harness is provided. The differential transmission cable 1 includes two electric wires, a non-conductive film that is wound around the two electric wires, and a sheath that is brought into contact with the periphery of the film in a filled state. The film has an adhesive layer in one surface of the film. The film is wound around the two electric wires such that the adhesive layer is arranged outside. In addition, the film is laterally wound around the two electric wires.

### CROSS-REFERENCES TO RELATED APPLICATIONS

This application is a based on and claims priority from Japanese Patent Applications No. 2017-183263 filed on Sep. 25, 2017, the entire contest of which are incorporated herein by reference.

### BACKGROUND OF THE INVENTION

### 1. Technical Field

The present invention relates to a differential transmission cable and a wire harness.

### 2. Background Art

Conventionally, a differential transmission cable used for transmitting a high frequency signal in a differential transmission system is known. The differential transmission cable has a configuration in which two electric wires each having a conductor and an insulator are twisted and a sheath is provided around the twisted two electric wires. In the differential transmission system, transmission signals whose phases are inverted 180 degrees from each other are simultaneously inputted to the two electric wires. On a receiving side, a difference between the two transmission signals can be synthesized to double a signal output.

For example, differential transmission cables described in PTLs 1 to 3 have been proposed as such a differential transmission cable. The differential transmission cable described in PTL 1 has a configuration in which a sheath is extruded as a tube around two electric wires. A twist direction of a stranded wire forming a conductor of each of the electric wires and a twist direction of the two electric wires are made opposite to each other, and a twist pitch of the stranded wire is set to be not larger than ¼ as long as a twist pitch of the two electric wires.

The differential transmission cable described in PTL 2 has a configuration in which a sheath is solidly extruded around two electric wires. The two electric wires are twisted spirally with a space away from each other, and the space between the two electric wires is filled with an insulating coating constituting the sheath.

The differential transmission cable described in PTL 3 has a configuration in which a sheath is provided around two electric wires that are twisted spirally. The differential transmission cable has inner-side protruding portions that are also formed spirally in order to suppress the two electric wires that are spirally twisted inside the sheath.

PTL 1: JP-A-2011-258330

PTL 2: JP-A-2015-162405

PTL 3: JP-A-2015-170431

### SUMMARY OF THE INVENTION

Here, as a method for extruding the sheath in the aforementioned differential transmission cable, solid extrusion or tube extrusion is used. FIG. 8 and FIG. 9 are sectional views showing differential transmission cables according to comparative examples. In the case where the solid extrusion is used, as shown in FIG. 8, a sheath resin enters spaces C between two electric wires W twisted together. Here, when the sheath resin has a higher relative dielectric constant than PP (polypropylene), PE (polyethylene), etc. that is used as the material of insulators of the electric wires W, or when the sheath resin has a conspicuously higher dielectric loss tangent than PP, PE, etc. (e.g. when the dielectric loss tangent exceeds 1×10⁻³), characteristic impedance is unstable and an insertion loss characteristic is reduced. Accordingly, it is preferable that the sheath resin is prevented from entering the spaces C between the two electric wires W.

On the other hand, in the case where the tube extrusion is used, as shown in FIG. 9, a contact area CA between each of two electric wires W and a sheath S is so small that adhesive strength therebetween is also small. Further, dimensional conditions for terminal processing of the differential transmission cable are severe. Accordingly, when each of the two electric wires W moves from the terminal side of the sheath S during the terminal processing due to the small adhesive strength between the electric wire W and the sheath S, transmission performance, particularly characteristic impedance, is unstable, and an insertion loss characteristic is reduced. Accordingly, it is preferable that the two electric wires W are fixed to the sheath S.

Here, the tube extrusion is carried out in the differential transmission cable described in PTL 1. Accordingly, the two electric wires are not fixed to the sheath to thereby lead to unstable characteristic impedance. On the other hand, the solid extrusion is carried out in the differential transmission cable described in PTL 2. Accordingly, the two electric wires are fixed to the sheath. However, a sheath resin enters the spaces between the two electric wires to thereby lead to unstable characteristic impedance. Moreover, it is necessary to perform extrusion molding of the sheath so as to keep a constant distance between the two electric wires. Therefore, the solid extrusion requires a considerable number of manufacturing man-hours in comparison with ordinary extrusion molding. Further, also as for the differential transmission cable described in PTL 3, the two electric wires are fixed to the sheath, but a sheath resin (the inner-side protruding portions) enters spaces between the two electric wires to thereby lead to unstable characteristic impedance.

As described above, the differential transmission cables described in PTLs 1 to 3 have a problem that the characteristic impedance is unstable and the number of manufacturing man-hours increases.

The present invention has been accomplished in order to solve such a problem inherent in the background art. An object of the invention is to provide a differential transmission cable and a wire harness, in which characteristic impedance can be made stable and an increase in the number of manufacturing man-hours can be suppressed.

The present invention provides a differential transmission cable including: two electric wires; a non-conductive film that is wound around the two electric wires; and a sheath which is brought into contact with the periphery of the film in a filled state. The film has an adhesive layer in one surface of the film. The film is wound around the two electric wires such that the adhesive layer is arranged outside.

According to the differential transmission cable, the non-conductive film is wound around the two electric wires, and the sheath is brought into contact with the periphery of the film and formed in the periphery of the file in the filled state. Accordingly, the two electric wires are fixed through the film by the sheath set in the filled state. At the same time, even when the sheath is set in the filled state, the film can prevent a sheath resin from entering spaces between the two electric wires. In addition, the sheath can be manufactured by ordinary extrusion without requiring control or the like on the distance between the two electric wires. Further, the film has the adhesive layer in its one surface, and the file is wound around the two electric wires such that the adhesive layer is arranged outside. Thus, adhesive strength between the film and the sheath can be enhanced so that the two electric wires can be fixed more firmly. Accordingly, characteristic impedance can be made stable and an increase in the number of manufacturing man-hours can be suppressed.

In the differential transmission cable according to the invention, preferably, the film is laterally wound around the two electric wires.

According to the differential transmission cable, the film is laterally wound around the two electric wires. Therefore, the film can be easily wound around the two electric wires while being pulled. Further, tension of the film can be enhanced so as to be able to more greatly prevent the sheath resin from entering the spaces between the two insulated electric wires

In addition, the invention provides a wire harness includes the differential transmission cable described in the above, and another member that contains a plasticizer and that is provided adjacent to the differential transmission cable.

The wire harness is provided with the differential transmission cable and the other member. The other member is provided adjacent to the differential transmission cable and contains the plasticizer. Therefore, it is possible to prevent such a situation that the plasticizer volatilized from the other member under a high temperature environment may migrate to insulators of the electric wires to thereby degrade an insertion loss characteristic.

According to the invention, it is possible to provide a differential transmission cable and a wire harness, in which characteristic impedance can be made stable and an increase in the number of manufacturing man-hours can be suppressed.

### BRIEF DESCRIPTION OF THE DRAWINGS

FIG. 1 is a perspective view of a wire harness including a differential transmission cable according to an embodiment of the present invention.

FIG. 2 is a perspective view showing the differential transmission cable shown in FIG. 1.

FIG. 3 is a sectional view showing the differential transmission cable shown in FIG. 1.

FIG. 4 is a graph for explaining an example of the differential transmission cable, and shows characteristic impedance of a first example.

FIG. 5 is a graph for explaining the example of the differential transmission cable, and shows an insertion loss characteristic of the first example.

FIG. 6 is a graph for explaining another example of the differential transmission cable, and shows characteristic impedance of a second example.

FIG. 7 is a graph for explaining the other example of the differential transmission cable, and shows an insertion loss characteristic of the second example.

FIG. 8 is a sectional view showing a differential transmission cable according to a first comparative example.

FIG. 9 is a sectional view showing a differential transmission cable according to a second comparative example.

### DESCRIPTION OF THE PREFERRED EMBODIMENT

The present invention will be described below along a preferred embodiment. Incidentally, the invention is not limited to the following embodiment but can be changed suitably without departing from the gist of the invention. In addition, in the following embodiment, illustration or description of a portion of a configuration will be omitted at some places. However, as for details of omitted techniques, it is a matter of course that publicly known or well-known techniques may be suitably applied without causing any contradiction to the contents that will be described as follows.

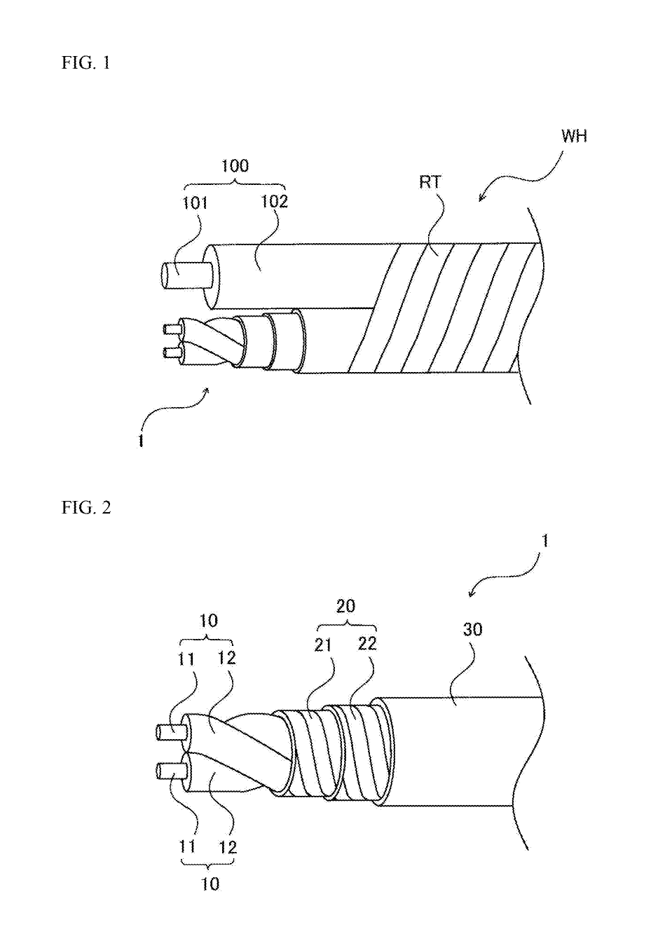

FIG. 1 is a perspective view of a wire harness including a differential transmission cable according to an embodiment of the present invention. As shown in FIG. 1, the wire harness WH includes a differential transmission cable 1 and another cable (another member) 100.

For example, the other cable 100 is a thick electric line such as an electric power line, or a thin electric line such as another signal line. The other cable 100 has a conductor 101 and an insulator 102 covering the periphery of the conductor. For example, the insulator 102 includes a plasticizer such as PVC (polyvinyl chloride). Further, the differential transmission cable 1 and the other cable 100 are taped by resin tape RT, or a corrugated tube (not shown), a terminal (not shown), a connector, or the like is attached to the differential transmission cable 1 and the other cable 100.

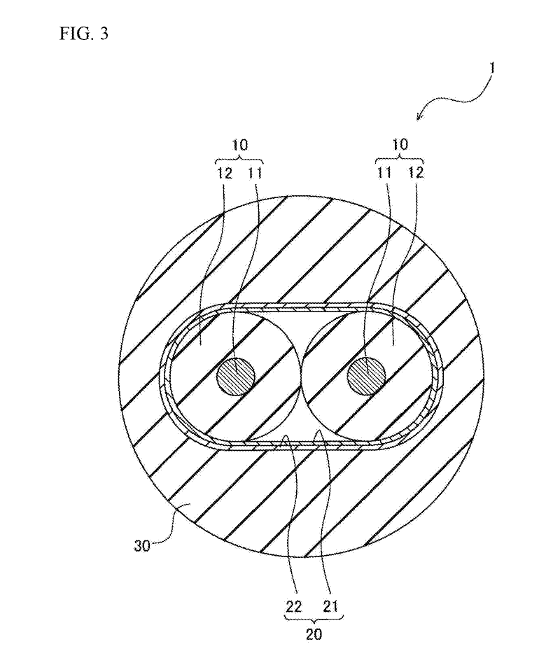

FIG. 2 is a perspective view showing the differential transmission cable 1 shown in FIG. 1. FIG. 3 is a sectional view showing the differential transmission cable 1 shown in FIG. 1. As shown in FIG. 2 and FIG. 3, the differential transmission cable 1 has two insulated electric wires (electric wires) 10, a film 20, and a sheath 30.

Each of the insulated electric wires 10 has a conductor 11 and an insulator 12 provided on the conductor 11. For example, an annealed copper wire, a silvered annealed copper wire, and a tinned annealed copper wire, a tinned copper alloy wire etc. may be used as the conductor 11. Also, although the conductor 11 is provided as one wire in the embodiment, the conductor 11 may be constituted by two or more element wires. The insulator 12 is a coating member covered on the conductor 11. For example, PE or PP or foamed PE or PP etc. may be used as the material of the insulator 12. The insulator 12 has a relative dielectric constant not higher than 2.5.

The film 20 is constituted by a non-conductive film. The film 20 is formed into a two-layer structure having a film layer 21 and an adhesive layer 22. Such film 20 is wound on the two insulated electric wires 10 so that the film layer 21 comes to the inside and the adhesive layer 22 comes to the outside. Therefore, the film 20 is adhesively bonded to the outside sheath 30 by the adhesive layer 22.

The film layer 21 is formed, for example, out of a PET (polyethylene terephthalate) resin having a difference of a predetermined value or more from an SP value of the plasticizer added in order to impart flexibility to PVC. It is preferable that the adhesive layer 22 is melted to exert an adhesively bonding function when the sheath 30 is extruded.

Herein, when the film 20 is not adhesively bonded to the sheath 30, the film 20 may be cut incompletely and stay behind in stripping processing of the sheath 30 in terminal processing of the differential transmission cable 1. In such a case, a worker may have to manually remove the film 20 staying behind. This causes an increase in processing time. In addition, when the film 20 is removed incompletely, there is a possibility that the film 20 may be caulked together during terminal crimping so that there is a possibility that crimp failure may be caused. However, when the film 20 is provided with the adhesive layer 22 as in the embodiment, the film 20 can be adhesively bonded to the sheath 30 through the adhesive layer 22 to thereby solve the aforementioned problem.

Further, in the embodiment, it is preferable that the film 20 is laterally wound (spirally wound) on the two insulated electric wires 10. This is because when the film 20 is laterally wound thus, the film 20 can be wound around the two insulated electric wires 10 in a state in which the film 20 has a predetermined or more level of tension.

Incidentally, it is preferable that no other member than the insulated electric wires 10 is received inside the film 20. This is because impedance change caused by the other member does not have to be taken into consideration.

The sheath 30 is an insulator that covers an outer circumference of the film 20. The sheath 30 is set in a filled state on the outer circumference side of the film 20. That is, the sheath 30 is not configured as a tube having an internal space but is provided in a so-called solid state. Such a sheath 30 is solidly extruded onto components including the two insulated electric wires 10 and the film 20. Thus, the sheath 30 is provided around the two insulated electric wires 10 and the film 20. The sheath 30 is formed, for example, out of a resin such as PVC having a relative dielectric constant not smaller than 2.5 or a dielectric loss tangent not smaller than 1.0×10⁻³.

Incidentally, the film layer 21 in the embodiment is formed out of the PET resin. Accordingly, the difference of the SP value is used to prevent the plasticizer from migrating to the insulator 12 formed out of PP or PE. That is, when the sheath 30 is formed out of PVC, there is a possibility that a plasticizer contained in the sheath 30 or the plasticizer from the insulator 102 of the other cable 100 may be volatilized under a high temperature environment and the volatilized plasticizer may migrate to the insulators 12 of the insulated electric wires 10 to thereby degrade an insertion loss characteristic. However, this can be prevented due to the PET resin in the embodiment.

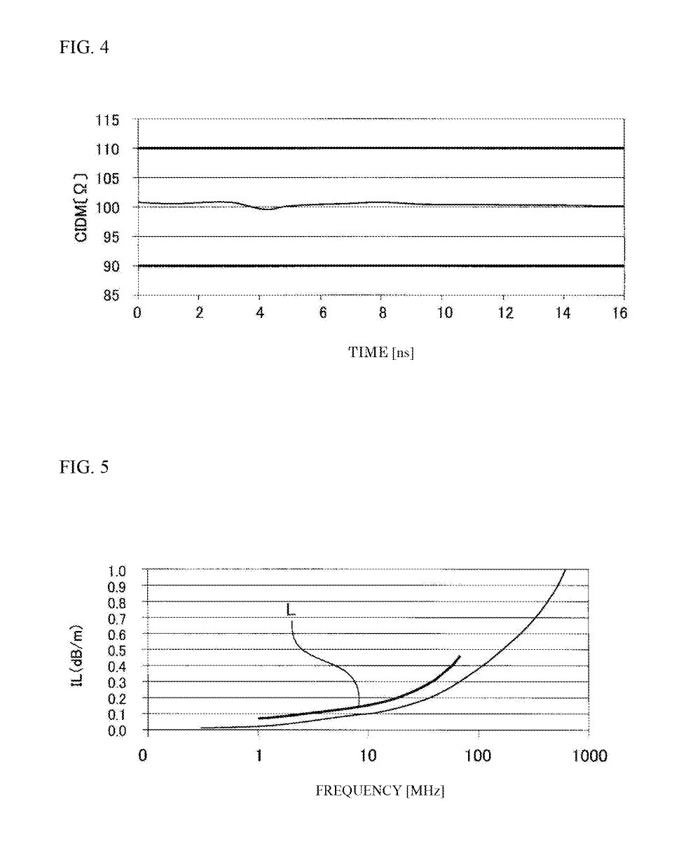

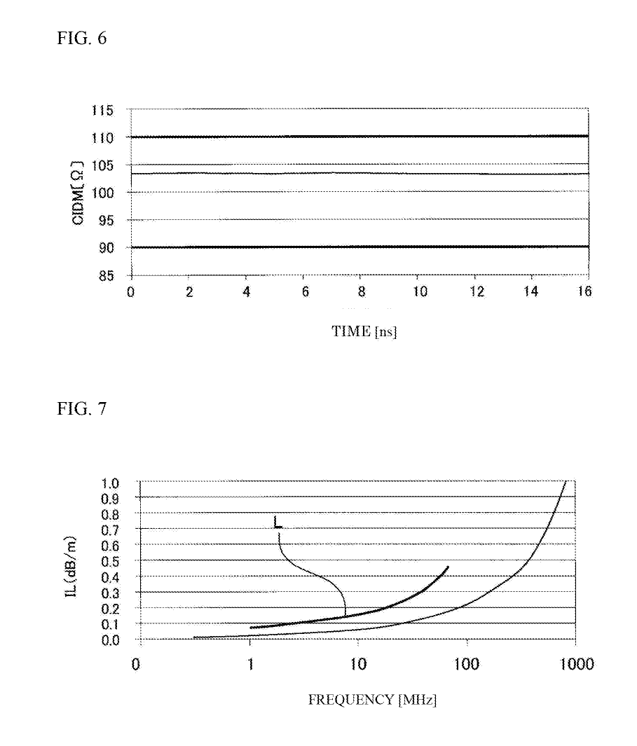

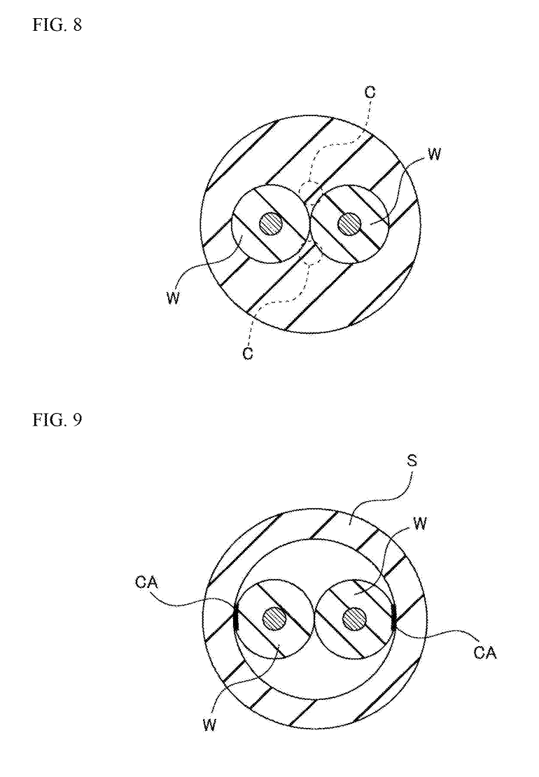

Next, characteristics of the differential transmission cable 1 according to the embodiment will be described. FIGS. 4 to 7 are graphs for explaining examples of the differential transmission cable. FIG. 4 shows characteristic impedance of a first example. FIG. 5 shows an insertion loss characteristic of the first example. FIG. 6 is characteristic impedance of a second example. FIG. 7 is an insertion loss characteristic of the second example. Incidentally, the characteristic of each of the examples in FIGS. 4 to 7 is indicated by a solid line and a characteristic of a standard value is indicated by a thick line.

First, the differential transmission cable of the first example was configured as follows. That is, a non-compressed copper alloy stranded wire having a configuration of 7/0.16 No/mm and an outer diameter of 0.480 mm was used as each of conductors. Thus, the conductor size was 0.13 sq. Crosslinked PE was used as the material of each of insulators. A finished outer diameter of each of two insulated electric wires was 0.83 mm. A twist outer diameter of the two insulated electric wires was 1.66 mm. A film was a sheath-side glued PET film 0.012 mm thick. The film was laterally wound on the two insulated electric wires. As a result, a finished outer diameter was 1.70 mm. Heat-resistant PVC (105° C.×3,000 h heat resistance) about 0.60 mm thick was used as the material of the sheath. A finished outer diameter as the differential transmission cable was 2.90 mm.

In addition, the differential transmission cable of the second example was configured as follows. That is, a non-compressed annealed copper stranded wire having a configuration of 7/0.26 No/mm and an outer diameter of 0.78 mm was used as each of conductors. Thus, the conductor size was 0.35 sq. Crosslinked PE was used as the material of each of insulators. A finished outer diameter of each of two insulated electric wires was 1.35 mm. A twist outer diameter of the two insulated electric wires was 2.70 mm. As a film, the same one as that according to the first example was used to be laterally wound on the two insulated electric wires. As a result, a finished outer diameter was 2.74 mm. Also as a sheath, the same one as that according to the first example was used. Consequently, a finished outer diameter as the differential transmission cable was 3.94 mm.

As shown in each of FIG. 4 and FIG. 6, a standard value of characteristic impedance in the differential transmission cable was not smaller than 90Ω and not larger than 110Ω. The characteristic impedance of the differential transmission cable according to the first example satisfied this standard value and was stable at about 100Ω. The characteristic impedance of the differential transmission cable according to the second example also satisfied the standard value and was stable to be not smaller than 102Ω and not larger than 103Ω.

In addition, an insertion loss characteristic in the differential transmission cable was required to be not larger than a standard value (line L) shown in each of FIG. 5 and FIG. 7. The insertion loss characteristic of the differential transmission cable according to each of the first example and the second example was not larger than such a line L.

Thus, according to the differential transmission cable 1 according to the embodiment, the electrically non-conductive film 20 is wound around the two insulated electric wires 10, and the sheath 30 is brought into contact with the periphery of the film 20 and set into the filled state. Accordingly, the two insulated electric wires 10 are fixed through the film 20 by the sheath 30 set in the filled state. At the same time, even when the sheath 30 is set in the filled state, the film 20 can prevent the sheath resin from entering spaces between the two insulated electric wires 10. In addition, for example, the sheath 30 can be manufactured by ordinary extrusion without requiring control or the like on the distance between the two insulated electric wires 10. Further, the film 20 having the adhesive layer 22 in its one surface is wound so that the adhesive layer 22 comes to the outside. Accordingly, adhesive strength between the film 20 and the sheath 30 can be enhanced so that the two insulated electric wires 10 can be fixed more firmly. Accordingly, characteristic impedance can be made stable and an increase in the number of manufacturing man-hours can be suppressed.

In addition, the film 20 having the adhesive layer 22 in its one surface is wound so that the adhesive layer 22 comes to the outside. Accordingly, when the sheath 30 is stripped during the terminal processing etc., the film 20 together with the sheath 30 can be stripped easily. Consequently, it is possible to reduce a possibility that electric conduction failure may be caused by the film 20 that stays behind to be put on the conductors of the insulated electric wires 10.

In addition, the film 20 is laterally wound around the two insulated electric wires 10. Accordingly, the film 20 can be easily wound around the two insulated electric wires 10 while being pulled. The tension of the film 20 can be enhanced so as to be able to more greatly prevent the sheath resin from entering the spaces between the two insulated electric wires 10.

In addition, the wire harness WH according to the embodiment is provided with the differential transmission cable 1 and the other cable 100. The other cable 100 has the insulator 102 that is adjacent to the differential transmission cable 1 and that contains the plasticizer. Accordingly, it is possible to prevent such a situation that the plasticizer from the insulator 102 of the other cable 10 volatilized under a high temperature environment may migrate to the insulators 12 of the insulated electric wires 10 to thereby degrade the insertion loss characteristic.

Although the invention has been described based on the embodiment, the invention is not limited to the aforementioned embodiment. The invention may be changed or combined with any well-known and publicly known techniques without departing from the gist of the invention.

For example, the film 20 is provided with the adhesive layer 22 in the differential transmission cable 1 according to the aforementioned embodiment. However, the invention is not limited thereto. The adhesive layer 22 may be dispensed with or the adhesive layer 22 may face the inside.

In addition, in the wire harness WH according to the aforementioned embodiment, migration of the plasticizer contained in the insulator 102 of the other cable 100 is assumed. The component disposed adjacently to the differential transmission cable 1 does not have to be the other cable 100, but may be any member as long as the member is adjacent to the differential transmission cable 1 and contains the plasticizer.

1. A differential transmission cable comprising:
two electric wires;
a non-conductive film which is wound around the two electric wires; and
a sheath which is brought into contact with the periphery of the film in a filled state; wherein
the film has an adhesive layer in one surface of the film, and
the film is wound around the two electric wires such that the adhesive layer is arranged outside.

2. The differential transmission cable according to claim 1, wherein:
the film is laterally wound around the two electric wires.

3. A wire harness comprising:
the differential transmission cable according to claim 1; and
another member which contains a plasticizer and is provided adjacent to the differential transmission cable.
